(19) United States
(12) Patent Application Publication
(10) Pub. No.: US 2012/0209784 A1
(43) Pub. Date: Aug. 16, 2012

(54) Systems and Methods for Providing a Practice Area Option

(75) Inventors: Scott Willette, Apex, NC (US); Jeffrey Harper, Garner, NC (US); Jennie Calavritinos, Clayton, NC (US); Audrey Mungal, Raleigh, NC (US); Christopher Anderson, Raleigh, NC (US); Michael Homsher, Raleigh, NC (US); Margaret Yahnker, Raleigh, NC (US)

(73) Assignee: LEXISNEXIS, A DIVISION OF REED ELSEVIER, INC., Miamisburg, OH (US)

(21) Appl. No.: 13/370,610

(22) Filed: Feb. 10, 2012

Related U.S. Application Data
(60) Provisional application No. 61/441,639, filed on Feb. 10, 2011.

(51) Int. Cl. G06Q 50/18

(52) U.S. Cl. 705/311

(57) ABSTRACT

Included are systems and methods for providing a practice area option. Some embodiments include providing an administrator interface that includes a practice area option to create a custom practice area grouping and providing an intake form option that includes a plurality of information sets. Similarly, some embodiments include providing an option to include the intake form into the custom practice area grouping and in response to receiving an indication to include the intake form into the custom practice area grouping, including the intake form into the custom practice area grouping. At least one embodiment includes providing a user interface for assigning a new client account to the custom practice area grouping and, in response to receiving information for at least one of the plurality of data fields, saving, by a computing device, the new client account.

### CROSS REFERENCE

This application claims the benefit of U.S. Provisional Application No. 61/441,639, filed on Feb. 10, 2011, which is hereby incorporated by reference in its entirety.

### BACKGROUND

1. Field

Embodiments provided herein generally relate to providing a practice area option, and particularly to providing customized areas of focus.

2. Technical Background

In many electronic search tools, documents and other information may be associated with a plurality of different areas of interest. While beneficial, oftentimes these search tools relate to searching case law, statutes, treatises, and other research-related documents. While these documents may be helpful to a professional, such as an attorney, oftentimes, a professional organization, such as a law firm has organizational information to be compiled. As an example, many law firms wish to track client information. However, many current systems, including online systems, are not customized for a particular area of law.

### SUMMARY

Included are systems and methods for providing a practice area option. Some embodiments include providing an administrator interface that includes a practice area option to create a custom practice area grouping and providing an intake form option that includes a plurality of information sets. Similarly, some embodiments include providing an option to include the intake form into the custom practice area grouping and in response to receiving an indication to include the intake form into the custom practice area grouping, including the intake form into the custom practice area grouping. At least one embodiment includes providing a user interface for assigning a new client account to the custom practice area grouping and, in response to receiving information for at least one of the plurality of data fields, saving, by a computing device, the new client account.

In another embodiment, a system for providing a practice area option may include a memory component that stores logic that, when executed by the system, causes the system to provide an administrator interface. The administrator interface may include a practice area option to create a custom practice area grouping, the custom practice area grouping for assigning a client account. The client account may relate to a practice area. An intake form option may also be included and configured for selecting a preferred information set to be included in an intake form. In some embodiments, the logic causes the system to receive a selection of the preferred information set from the plurality of information sets for including the plurality of information set-specific data fields in the practice area grouping and provide a conflict of interest option for comparing at least a portion of the information for at least one of the plurality of data fields against similar fields for a different client account to determine a potential conflict. In still some embodiments, the logic causes the system to, in response to determining the potential conflict, send an alert to a client manager.

In yet another embodiment, a system for providing a practice area option may store logic that, when executed by the system, causes the system to provide a user interface for assigning a new client account to a practice area grouping, the practice area grouping being created by an administrator through the use of a plurality of information sets that are grouped as an intake form. Each of the plurality of information sets may include a plurality of data fields. The user interface may include the plurality of data fields for receiving user input that is specific to the new client account. In some embodiments, the logic causes the system to provide a conflict of interest option for comparing at least a portion of the information for at least one of the plurality of data fields against similar fields for a different client account to determine a potential conflict and, in response to determining the potential conflict, send an alert to a user.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for providing a practice area option, according to one or more embodiments shown and described herein;

FIG. 2 depicts a remote computing device for providing a practice area option, according to one or more embodiments shown and described herein;

FIG. 3 depicts an administrator interface for providing practice area configuration data, according to one or more embodiments shown and described herein;

FIG. 4 depicts an administrator interface for adding a practice area, according to one or more embodiments shown and described herein;

FIG. 5 depicts an administrator interface for managing intake forms, according to one or more embodiments shown and described herein;

FIG. 6 depicts a user interface for providing a home screen, according to one or more embodiments shown and described herein;

FIG. 7 depicts a user interface for adding a client matter, according to one or more embodiments shown and described herein;

FIG. 8 depicts a user interface for viewing client details, according to one or more embodiments shown and described herein;

FIG. 9 depicts a user interface for editing client details, according to one or more embodiments shown and described herein;

FIG. 10 depicts a user interface for providing matter details, according to one or more embodiments shown and described herein;

FIG. 11 depicts a user interface for editing matter details, according to one or more embodiments shown and described herein;

FIG. 12 depicts a user interface of a toolbar interface that may be provided for searching and/or providing administrative interfaces, according to one or more embodiments shown and described herein;

FIG. 13 depicts a user interface for providing searching capabilities, according to one or more embodiments shown and described herein;

FIG. 14 depicts a conflict of interest interface for searching a conflict, according to one or more embodiments shown and described herein;

FIG. 15 depicts a conflict of interest interface for providing results to a conflict search, according to one or more embodiments shown and described herein;

FIG. 16 depicts a conflict of interest interface for providing a saved conflict search, according to one or more embodiments shown and described herein; and

FIG. 17 depicts a flowchart for providing a practice area option, according to one or more embodiments shown and described herein.

### DETAILED DESCRIPTION

Embodiments disclosed herein include systems and methods for providing a practice area option. Some embodiments provide a user with one or more options to search content across sources such as relational database. Architectural guidelines are included and provide federated search implementation so that more content sources can be added as business demands change. Similarly, some embodiments support various content sources and provide a solution for conflict of interest search-related business requirements. Embodiments of the conflict of interest searching also adhere to security of content as well as to provide sufficient information to the user so that the user can make conflict-related business decisions.

Still some embodiments provide user options for authorized users to configure their own custom practice areas. This allows the user to more easily gather specific information pertinent to a matter. This customization may be performed on an entity specific-basis, meaning that the practice areas that are configured may be used by all the users in the entity (such as a law firm), and will not be seen by other entities. For the practice areas, authorized users may create one or more intake forms. Intake forms are a group of information sets that the user configures, which contain data that the user can collect for a client on the matter or for the matter itself.

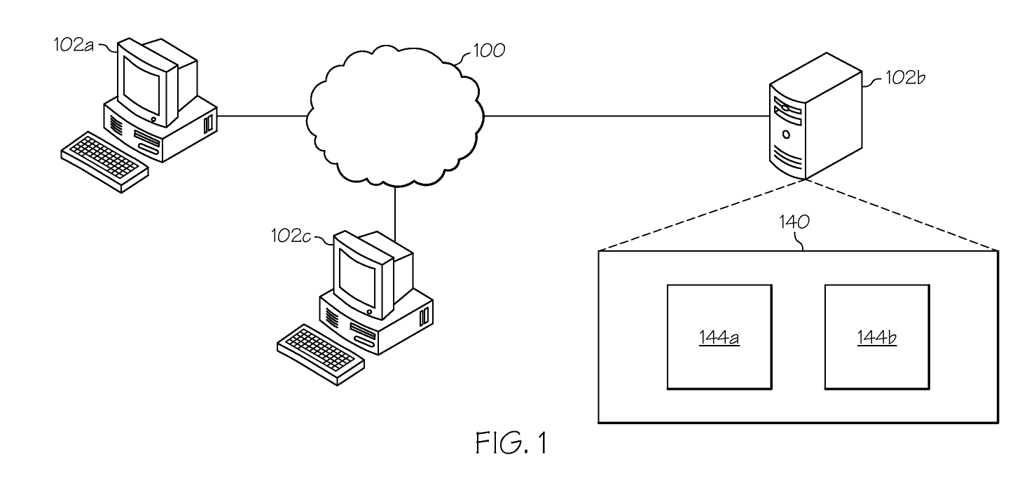

Referring now to the drawings, FIG. 1 depicts a computing environment for providing a practice area option, according to one or more embodiments shown and described herein. As illustrated, a network 100 may be coupled to a user computing device 102a, a remote computing device 102b, and an administrator computing device 102c. The network 100 may include a wide area network and/or a local area network and thus may be wired and/or wireless. The user computing device 102a may include any portable and/or non-portable computing devices, such as personal computers, laptop computers, personal digital assistants (PDAs), mobile phones, etc.

Similarly, the remote computing device 102b may include a server and/or other computing device for providing information to the user computing device 102a via a request to the conflict of interest logic 144b. In some embodiments, the remote computing device 102b may be configured to provide an online research tool, such as a legal research website, individual research tool, business tool, etc. As discussed in more detail below, the user computing device 102a may include a memory component 144 that stores practice area logic 144a and conflict of interest logic 144b to provide this functionality. The practice area logic 144a may include software, hardware, and/or firmware for providing customization options with regard to practice area options in a client computing system. Similarly, the conflict of interest logic 144b may include software, hardware, and/or firmware for providing a search tool for determining conflict of interest issues.

Additionally, the remote computing device 102b may provide information and/or interfaces to the administrator computing device 102c for setting up and/or managing a client account, including a new client, a new client matter, and/or for performing other administrative actions. The administrator computing device 102c may be configured as a personal computer, server, PDA, mobile phone, etc.

It should be understood that while the user computing device 102a, the remote computing device 102b, and the administrator computing device 102c are represented in FIG. 1 each as a single component, this is merely an example. More specifically, in some embodiments, there may be numerous different components that provide the described functionality. However, for illustration purposes, single components are shown in FIG. 1 and described herein.

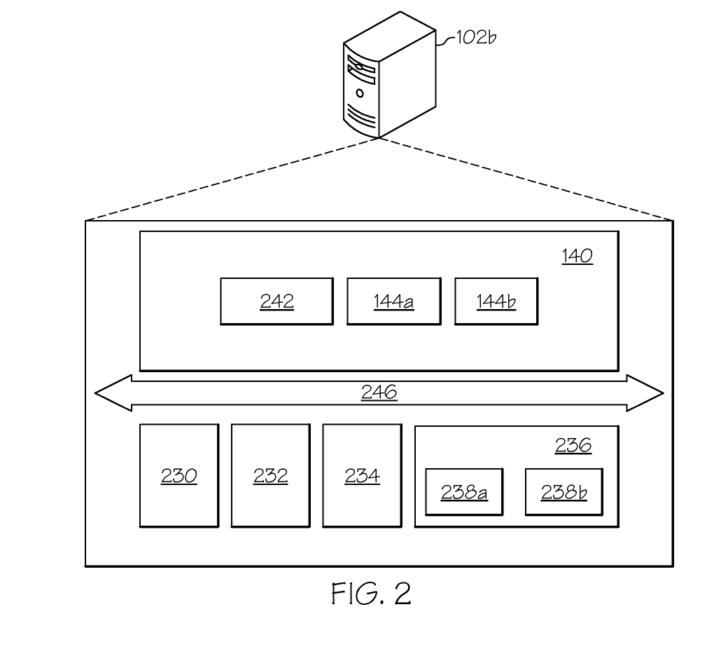

FIG. 2 depicts a remote computing device 102b for providing a practice area option, according to one or more embodiments shown and described herein. In the illustrated embodiment, the remote computing device 102b includes a processor 230, input/output hardware 232, network interface hardware 234, a data storage component 236 (which stores firm data 238a, area of focus data 238b, and/or other data), and the memory component 144. The memory component 144 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the remote computing device 102b and/or external to the remote computing device 102b.

Additionally, the memory component 144 may store operating logic 242, the practice area logic 144a, and the conflict of interest logic 144b. The practice area logic 144a and the conflict of interest logic 144b may each include a plurality of different pieces of logic, each of which may be embodied as a computer program, firmware, and/or hardware, as an example. A local interface 246 is also included in FIG. 2 and may be implemented as a bus or other interface to facilitate communication among the components of the remote computing device 102b.

The processor 230 may include any processing component operable to receive and execute instructions (such as from the data storage component 236 and/or the memory component 144). The input/output hardware 232 may include and/or be configured to interface with a monitor, positioning system, keyboard, mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the remote computing device 102b and other computing devices.

The operating logic 242 may include an operating system and/or other software for managing components of the remote computing device 102b. Similarly, as discussed above, the practice area logic 144a may reside in the memory component 144 and may be configured to cause the processor 230 to provide one or more options for customizing client recordation and management. As an example, if the user is a law firm professional who has clients in a particular area of the law, the company may utilize the practice area logic 144a to customize searching capabilities and options, based on that data. Thus, when any member of the company accesses the remote computing device 102b to retrieve data regarding that area of focus, those users are provided with the data, as determined via the practice area logic 144a. Similarly, the conflict of interest logic 144b may be utilized to provide searching capabilities and may be configured for execution in conjunction with the practice area logic 144a. Other functionality is also included and described in more detail, below.

It should be understood that the components illustrated in FIG. 2 are merely exemplary and are not intended to limit the scope of this disclosure. While the components in FIG. 2 are illustrated as residing within the remote computing device 102b, this is merely an example. In some embodiments, one or more of the components may reside external to the remote computing device 102b. It should also be understood that, while the remote computing device 102b in FIG. 2 is illustrated as a single device, this is also merely an example. In some embodiments, the practice area logic 144a and the conflict of interest logic 144b may reside on different devices.

Additionally, while the remote computing device 102b is illustrated with the practice area logic 144a and the conflict of interest logic 144b as separate logical components, this is also an example. In some embodiments, a single piece of logic may cause the remote computing device 102b to provide the described functionality.

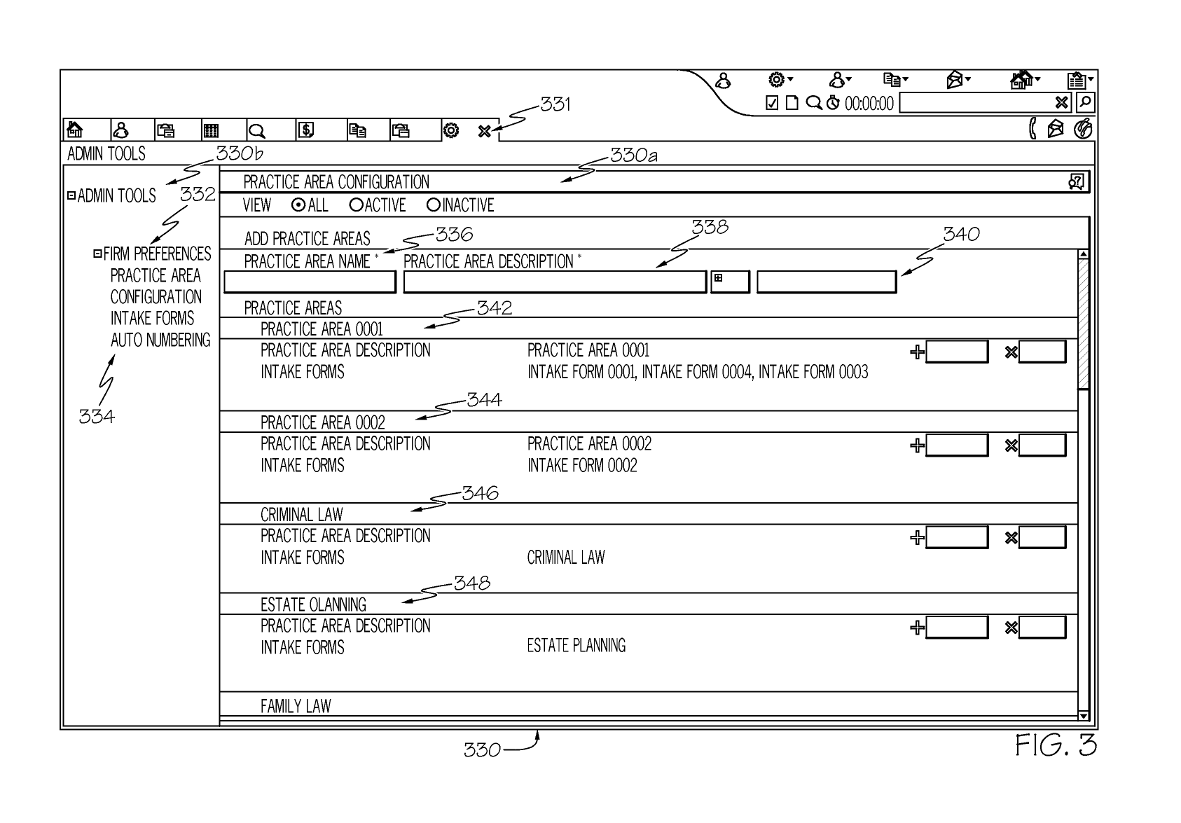

FIG. 3 depicts an administrator interface 330 for providing practice area configuration data, according to one or more embodiments shown and described herein. The administrator interface 330 may be provided to a company administrator on the administrator computing device 102c. Depending on the embodiment, the administrator may be a law firm administrator and the administrator interface may provide the administrator with options for managing client accounts. The administrator interface 330 includes a practice area configuration frame 330a and a sidebar frame 330b. The practice area configuration frame 330a and the sidebar frame 330b may be provided after selecting the admin tools option 331 and authenticating the administrator.

The practice area configuration frame 330a may provide options for adding a practice area. More specifically, oftentimes clients may retain a professional to provide a particular service. As an example, John Smith may retain an attorney at a law firm to provide criminal law representation. As such, the law firm may request and store certain types of information about John Smith that may differ from the information that is requested for an estate planning client. Accordingly, the practice area configuration frame 330a may provide the administrator with options for creating practice areas to accommodate the various types of clients that the company serves. A practice area name text prompt 336 may be provided, as well as a practice area description text prompt 338. In creating a new practice area, the administrator may enter the requested data into the text prompts 336, 338 and select an add option 340.

Also included in the practice area configuration frame 330a are other practice areas 342-348 that have been created for the company. The other practice areas 342-348 may include a practice area 0001 342 and a practice area 0002 344, which have been created, but not activated. Accordingly, an activate option 350a, 350b may be provided to activate a practice area. A delete option 352a, 352b may be selected to delete a practice area.

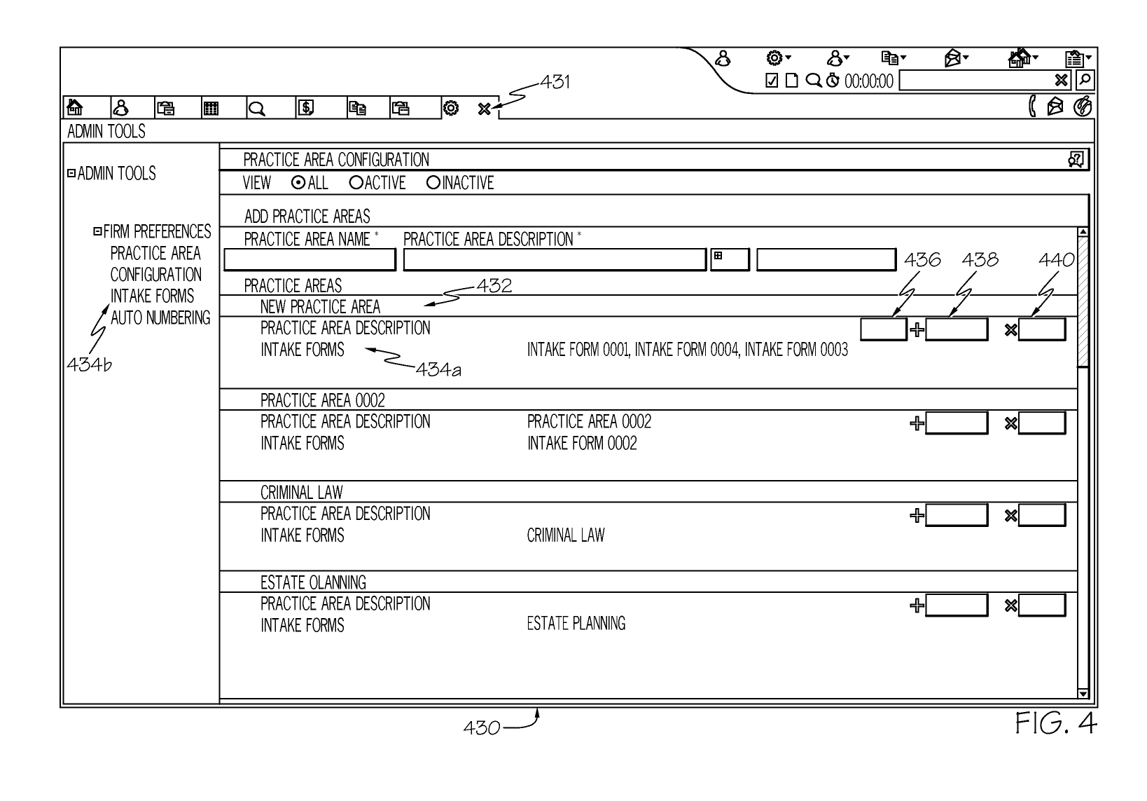

FIG. 4 depicts the administrator interface 330 for adding a practice area, according to one or more embodiments shown and described herein. As illustrated, in response to selection of the add option 340 (FIG. 3), the administrator interface 330 may add the new practice area 432 to the list of practice areas. The new practice area 432 may also include a deactivate option 436, an edit option 438, and a delete option 440. Also included are intake forms options 434a, 434b, which provide the administrator with options for customizing intake forms that are associated the practice area. As described in more detail below, the associated intake forms may then be used for including a plurality of information sets, and thus, a plurality of data fields for a particular client account.

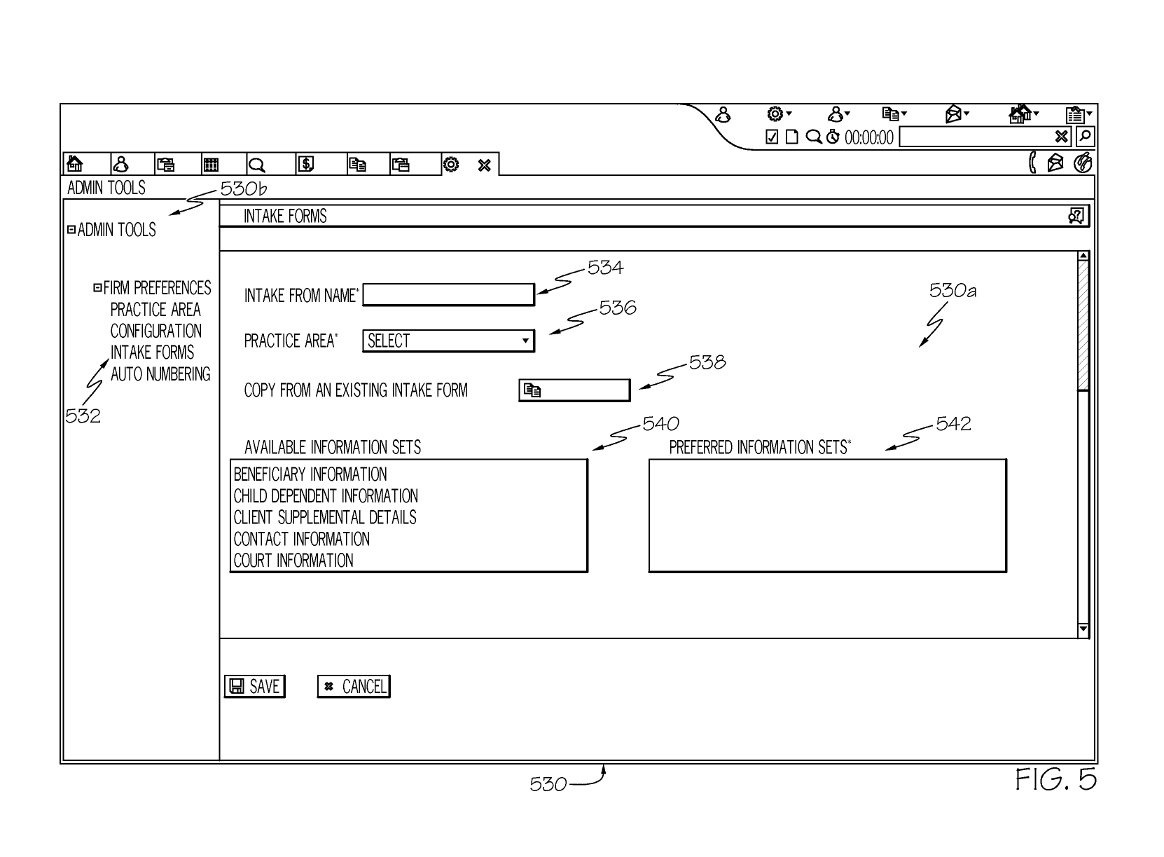

FIG. 5 depicts an administrator interface 530 for managing intake forms, according to one or more embodiments shown and described herein. In some embodiments, intake forms include one or more simply information sets that the administrator configures for inclusion into a practice area. Information sets may contain one or more data fields that are configured to receive client data or for a client account. The data fields may include a name field, a location field, a history field, and/or any other information, as described in more detail below. In configuring the practice area, as described with reference to FIG. 3, the administrator may select the desired intake forms for providing the desired data fields for that practice area.

Accordingly, FIG. 5 depicts a mechanism for determining the information sets that are used in an intake form. As such, the administrator interface 530 includes an intake form frame 530a and sidebar frame 530b. The sidebar frame 530b may include an intake form option 532. The intake form frame 530a may include an intake form name field 534 for receiving an administrator designated name for the intake form. Also included are a “practice area” option 536, and a “copy from existing form” option 538 for utilizing an existing intake form as a template for the new intake form. The practice area option 536 may be used to select one of the practice fields, as is managed in the administrator interfaces 430, 530, from FIGS. 4 and 5. The copy from existing form option 538 is also included and allows the administrator to use a previously created intake form as a template for the new intake form.

The available information sets window 540 may also be provided and lists the available information sets that may be utilized for the new intake form. An information set may include a plurality of fields for including in the intake form. As an example, the beneficiary information set may include data fields, such as a name field, an address field, a spouse field, a client goal field, and/or other information, as described in more detail below. While in some embodiments, the information sets provided in the available information sets window 540 are dependent on the practice area selected in the practice area option 536, this is merely an example. In some embodiments, all available information sets may be provided, regardless of the practice area selected in the practice area option 536. Upon selection of a preferred information set in the available information sets window 540, the preferred information sets may appear in a preferred information sets window 542. In response to the user saving the new intake form, the new intake form may be utilized for a practice group, as described above.

It should be understood that with reference to FIGS. 3-5, some embodiments may include a default option for providing at least one default practice area and/or at least one default intake form. As an example, the default practice areas may include areas such as “generic,” “litigation,” “real estate,” and “transactional.” Similarly, the intake forms may include “generic,” “litigation,” “real estate,” and “transactional.” Other default practice areas and intake forms may also be utilized, depending on the particular embodiment.

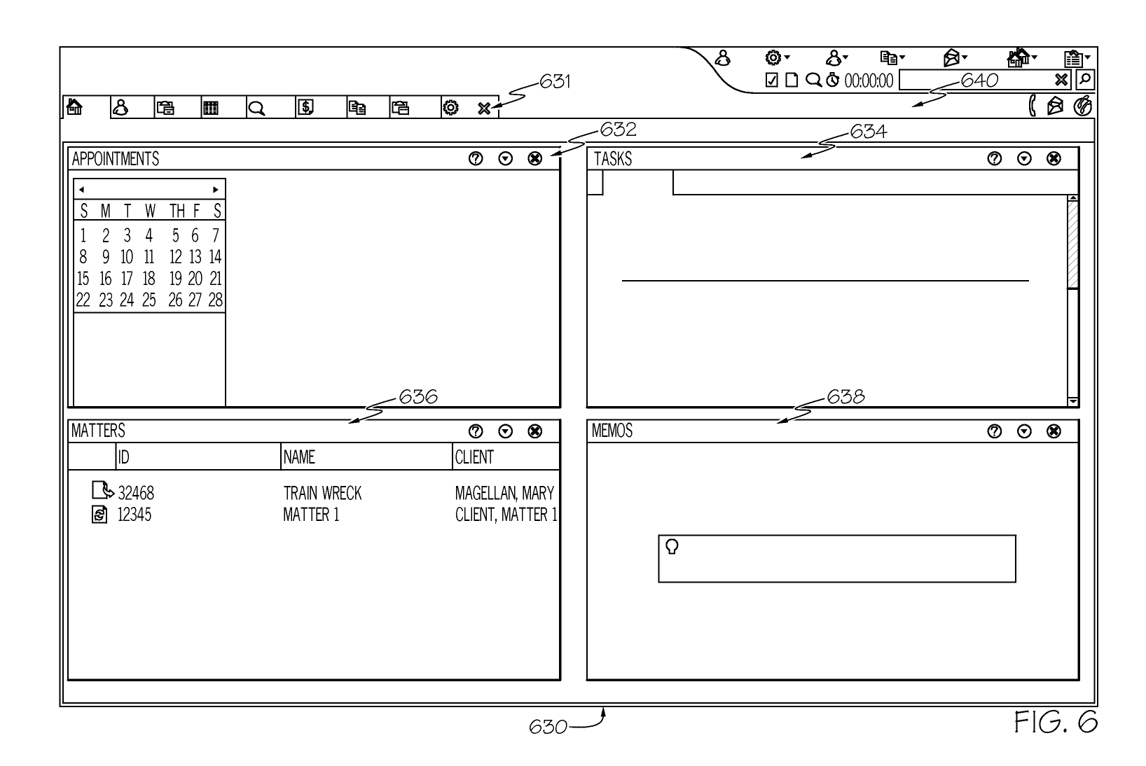

FIG. 6 depicts a user interface 630 for providing a user home screen, according to one or more embodiments shown and described herein. While FIGS. 3-5 depict administrator interfaces, FIGS. 6-16 depict user interfaces that may be utilized by a professional and/or assistant of the professional. Accordingly, the user interface 630 may be accessed by selection of a home tab 631 and may include a plurality of frames. The plurality of frames may include appointments frame 632, a tasks frame 634, a matters frame 636, and a memos frame 638. The appointments frame 702 may provide any appointments that the user has. The tasks frame 704 may provide any upcoming and/or overdue tasks. The matters frame 706 may provide any matters that the user has been given access. The memos frame 708 may provide any memos created by the user or other authorized users.

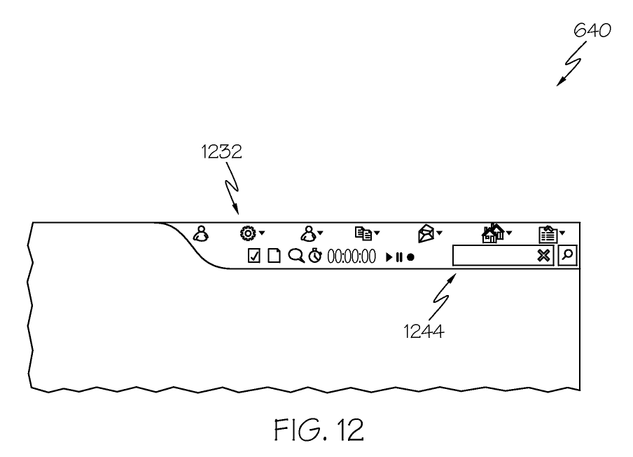

Also included in the user interface 630 is a toolbar interface 640. As described in more detail with reference to FIG. 12, the toolbar interface 640 may be configured to facilitate user searching, as well as provide an additional portal for administrator access of the administrator interfaces 330 and 530, described with reference to FIGS. 3-5.

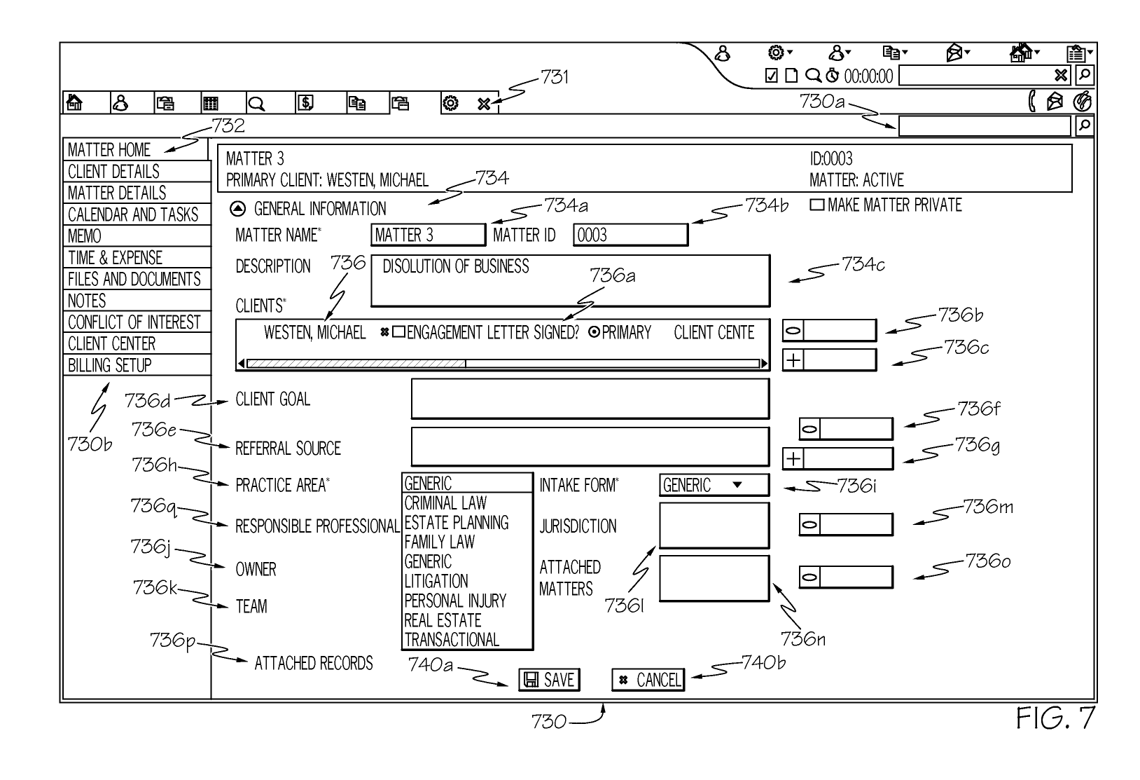

FIG. 7 depicts a user interface 730 for adding a client matter, according to one or more embodiments shown and described herein. As illustrated, the user interface 730 may include a matter home frame 730a and a sidebar frame 730b. The sidebar frame 730b may include a “matter home” option 732, a “client details” option, a “matter details” option, a “calendar and tasks” option, a “memo” option, a “time and expense” option, a “files and documents” option, a “notes” option, a “conflict of interest” option, a “client center” option, and a “billing setup” option.

In response to selection of a matter tab 731 and/or a matter home option 732, the matter home frame 730a may be provided. The matter home frame 730a may include a general information set 734, which includes a matter name field 734a, a matter identifier field 734b, and a description field 734c. A clients information set 736 may include a client field 736a that provides one or more clients that are associated with this particular matter. The client field 736a may also include an engagement letter option for the user to select whether an engagement letter has been executed for the client. The clients information set 736 may also include a look up option 736b to provide search functionality for locating a client. An add client option 736c may also be included for adding a new client to the matter.

Also included in the clients information set 736 is a client goal field 736d. The client goal field 736d may include a text prompt for a user to input a goal for a client. Similarly, a referral source field 736e may include a text prompt for the user to input a referrer of this client. A look up option 736f may facilitate a search for the referral source. An add referral option 736g may facilitate adding the referral source. Additionally included is a practice area field 736h. The practice area field 736h may include an option to select one or more of the practice areas created in FIGS. 3 and 4. An intake form field 736i is also provided and may be configured to provide an option to select one or more of the intake forms discussed in FIGS. 3-5. The practice area field 736h may include an option to select any of the practice areas discussed above. Based on that selection, the intake form field 736i may only provide intake forms that are associated with the selected practice area. Regardless, once the practice area and intake form are selected, other information sets (and thus data fields) may be provided, based on those selections.

Also included in the matter home frame 730a are an owner field 736j, a team field 736k, and a jurisdiction field 736l. The jurisdiction field 736l may also include a look up option 736m. Similarly, an attached matters field 736n may include an attach option 736o. A responsible professional field 736q may also be provided. The matter home frame 730a also includes an attached records field 736p for receiving records related to this matter. A save option 740a and a cancel option 740b is also included.

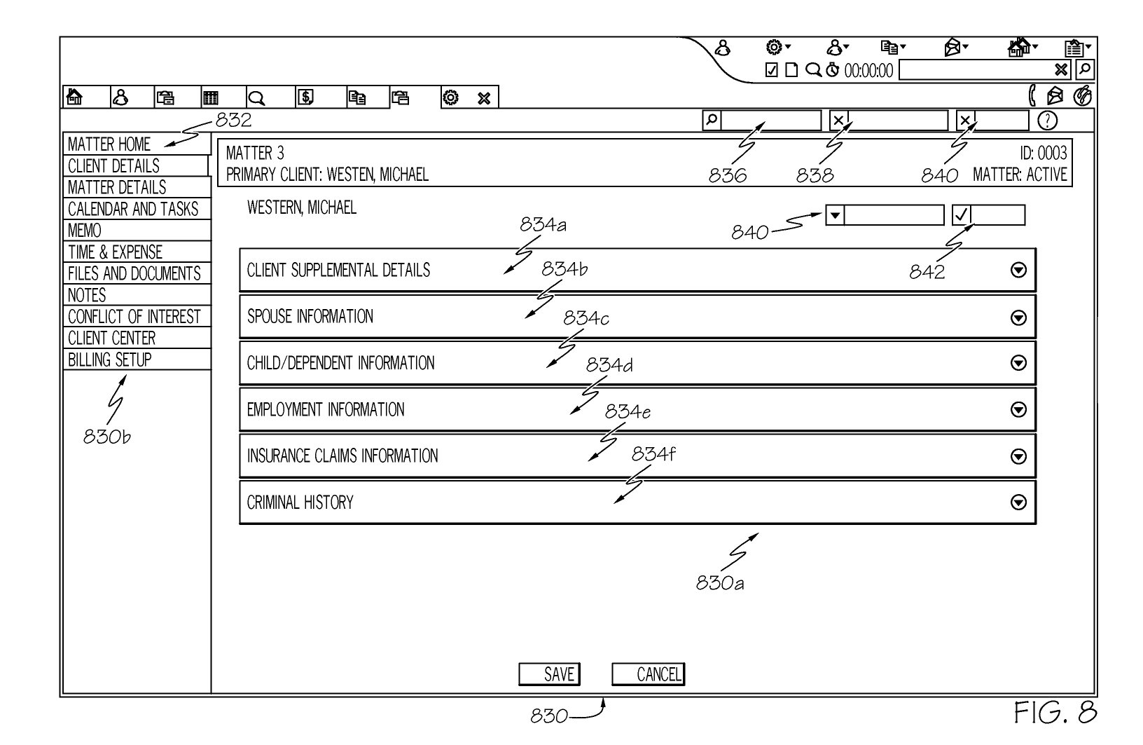

FIG. 8 depicts a user interface 830 for viewing client details, according to one or more embodiments shown and described herein. As illustrated, the user interface 830 includes a client details frame 830a and a sidebar frame 830b. The client details frame 830a may be provided in response to election of a client details option 832. Regardless, the client details frame 830a may include a plurality of information sets 834 that are associated with an intake form selected for the particular client. The data fields provided in FIG. 7 may be related to information sets that are generic to all client accounts and/or all client accounts in a predetermined practice group. The information sets depicted in FIG. 8, however, may be selected by the administrator as being part of the intake form depicted in FIG. 5. As such, the information sets of FIG. 8 include a client supplemental details information set 834a, a spouse information set 834b, a dependent information set 834c, an employment information set 834d, an insurance claims information set 834e, and a criminal history information set 834f. Also included are a view matter summary option 836, a close matter option 838, and a delete matter option 840.

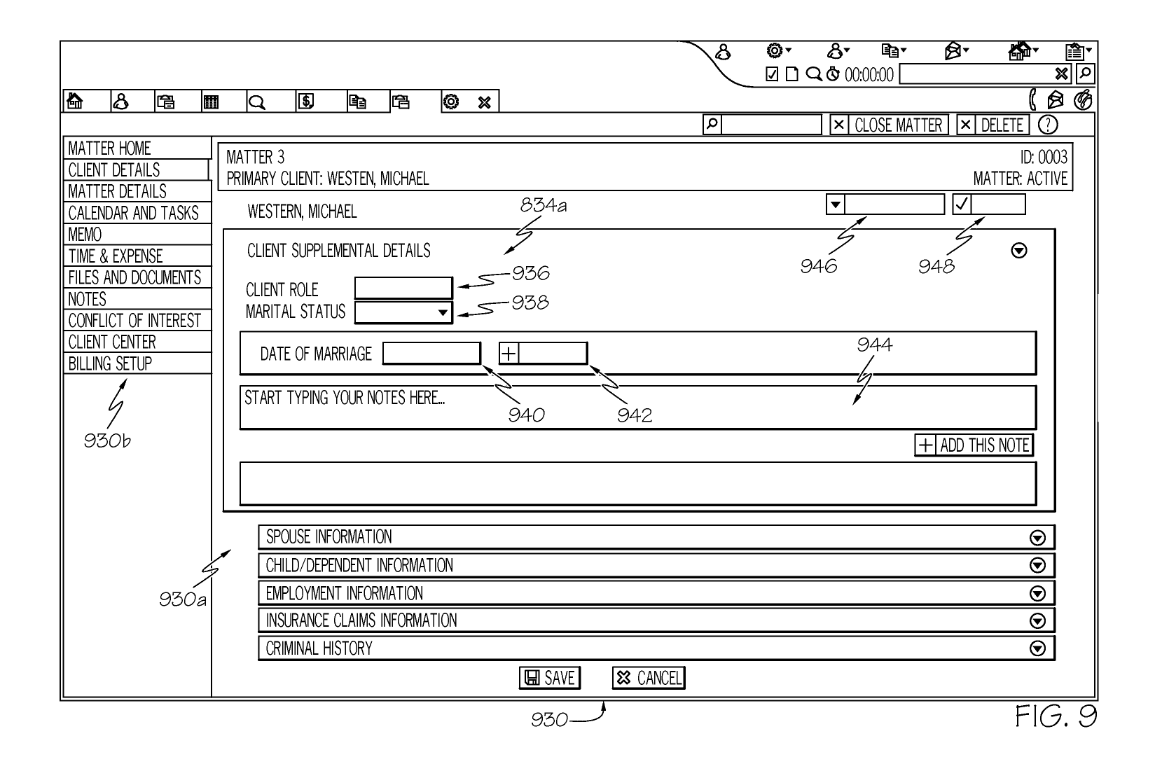

FIG. 9 depicts a user interface 930 for editing client details, according to one or more embodiments shown and described herein. As illustrated, the user interface 830 includes an expanded client details frame 930a and a sidebar frame 930b. The expanded client details frame 930a may include a plurality of data fields associated with a preferred information set. In response to selection of the client supplemental details information set 834a from FIG. 8, the user may be provided with a client role data field 936, a marital status data field 938, a date of marriage data field 940, an add more data field 942, and a notes data field 944. Also included is an expand all option 946 for providing additional information sets. An edit option 948 is also provided for editing the presence and/or content of the information sets that are listed in the user interface 930.

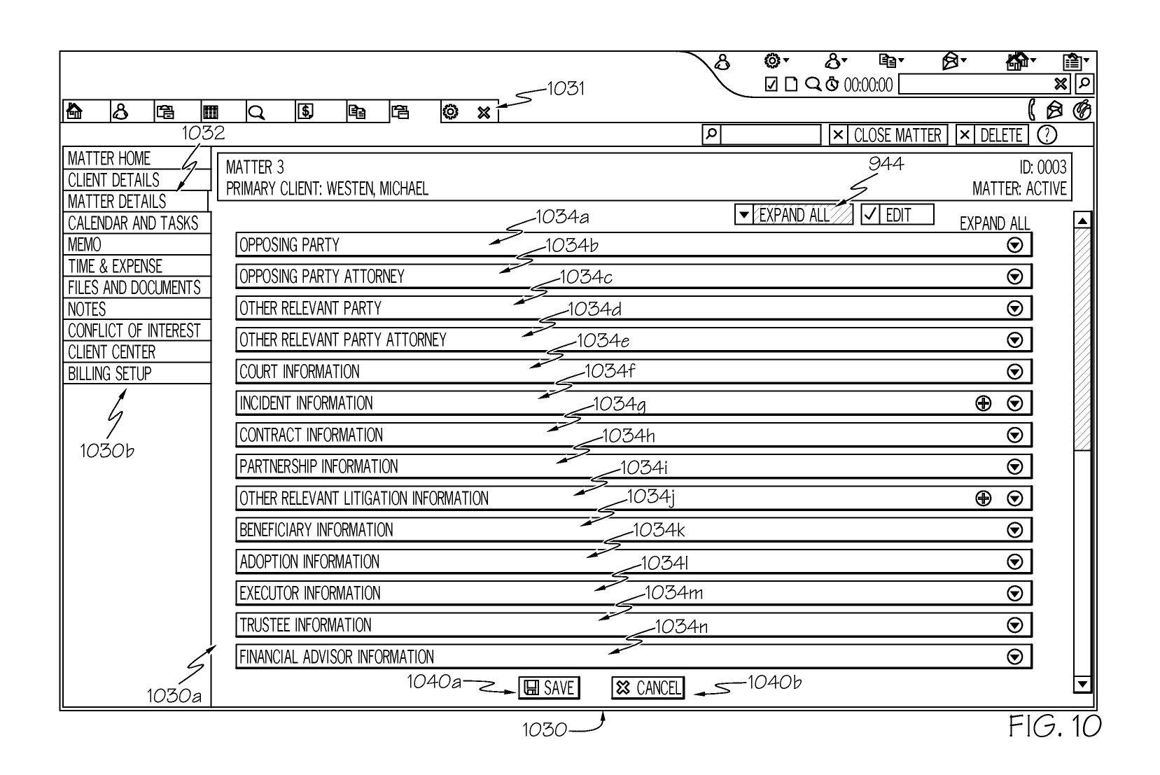

FIG. 10 depicts a user interface 1030 for providing matter details, according to one or more embodiments shown and described herein. As illustrated, the user interface 1030 includes a matter details frame 1030a and a sidebar frame 1030b. With the embodiments depicted in FIGS. 8 and 9 depict information sets for a particular client, the matter details frame 1030a includes a listing of information sets that may be provided for a particular client matter. In response to selecting a matter details option 1032 in the sidebar frame 1030b, information sets for the client matter may be provided. The information sets may include an opposing party information set 1034a, an opposing party attorney information set 1034b, an other relevant party information set 1034c, an other relevant party attorney information set 1034d, a court information set 1034e, an incident information set 1034f, a contract information set 1034g, a partnership information set 1034h, an other relevant litigation information set 1034i, a beneficiary information set 1034j, an adoption information set 1034k, an executor information set 10341, a trustee information set 1034m, and a financial advisor information set 1034n. By selecting one or more of the information sets (collectively referred to as “information sets 1034”), the associated data fields may be provided to the user for editing. A save option 1040a and a cancel option 1040b are also provided.

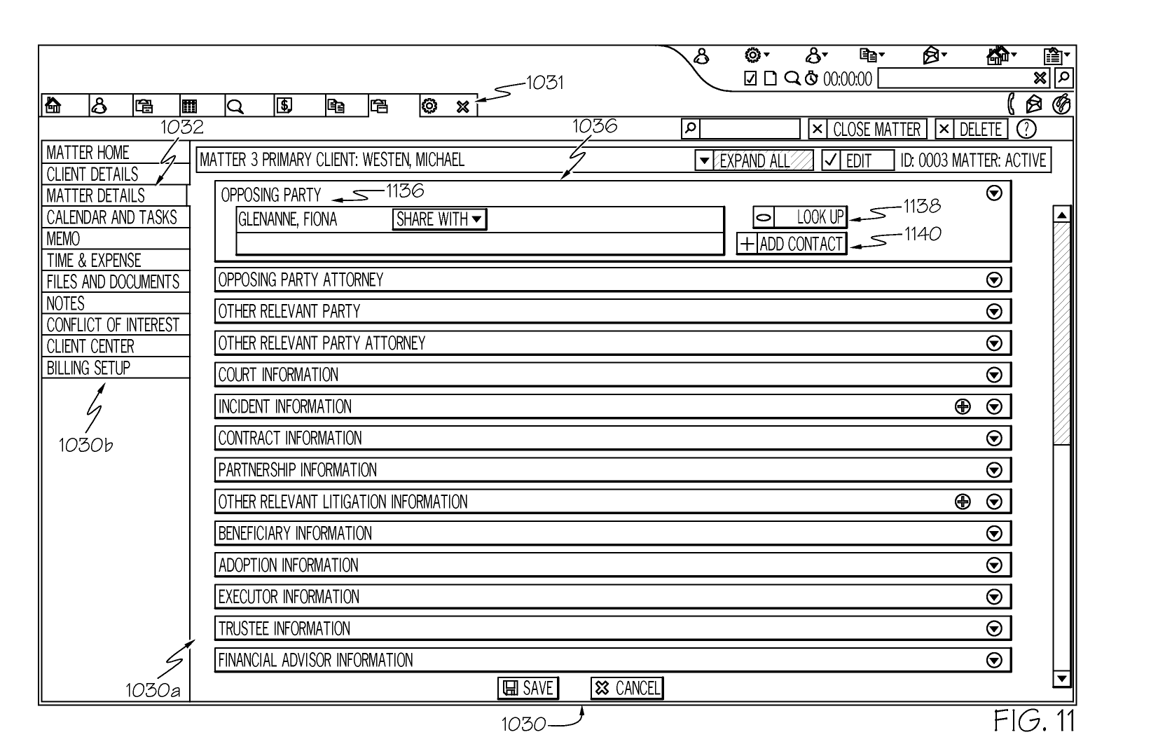

FIG. 11 depicts the user interface 1030 for editing matter details, according to one or more embodiments shown and described herein. As illustrated, the opposing party information set 1036 has been expended to provide an opposing party data field 1136. From the opposing party data field, the user can add an opposing party with a look up option 1138 and/or an add contact option 1140. Also included is a share with option for providing permissions for viewing the opposing party data.

FIG. 12 depicts the toolbar interface 640 (from FIG. 6) that may be provided for searching and/or providing administrative interfaces, according to one or more embodiments shown and described herein. As illustrated, the toolbar interface 640 may include an admin tools option 1232, and a keyword search field 1234. In response to selection of the admin tools option 1232, the administrator interfaces depicted in FIGS. 3-5 may be provided (upon an administrator authentication). The keyword search field 1234 may facilitate a global search function for searching the client accounts according to any of a plurality of criteria. Additional options for filtering the search may also be provided, as described in more detail below.

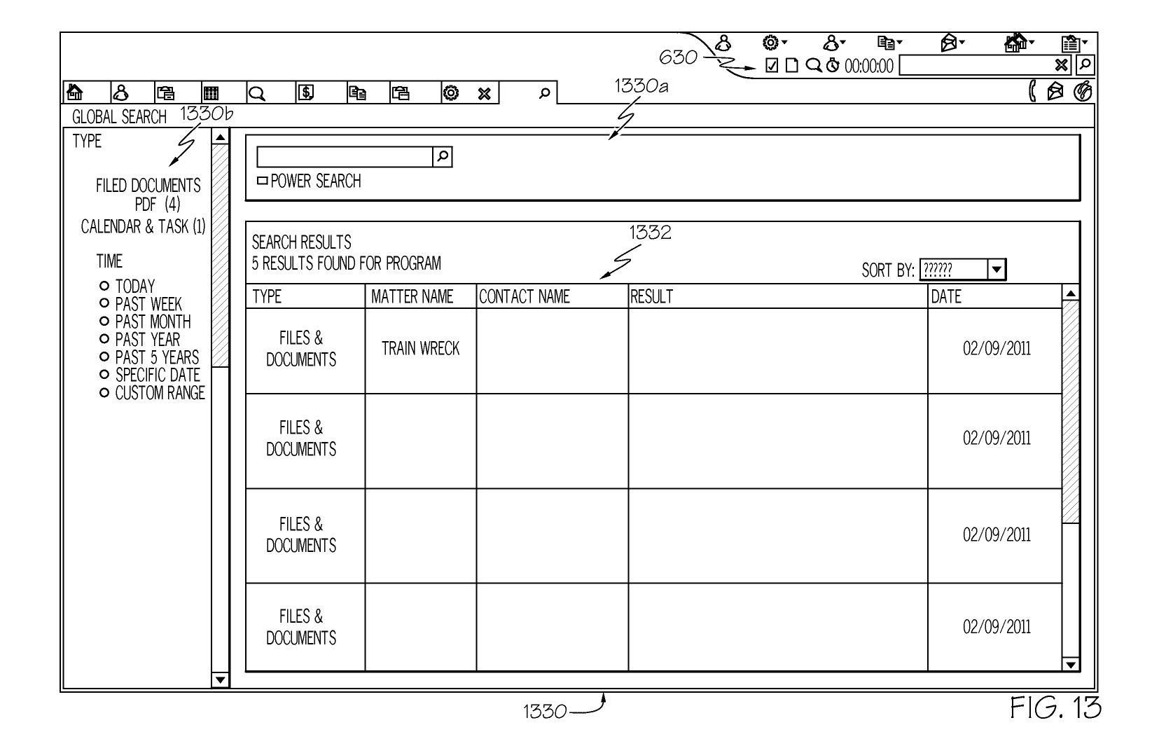

FIG. 13 depicts a user interface 1330 for providing searching capabilities, according to one or more embodiments shown and described herein. As illustrated, the user interface 1330 includes a search field frame 1330a for receiving a keyword for searching and a sidebar frame 1330b. Within the search field frame 1330a, is a results area 1332, which may provide a type of result, a matter to which the result is associated, a contact name, a result description, and a date. The sidebar frame 1330b includes additional search options, such as a type of data to search, a document type, and a time. Other options may also be provided. As illustrated, the user may perform a keyword or other search and may additionally filter search results based on matter type of search result, matter name, contact name, date, calendar and tasks, contact, files and documents, matter, memo, time and expense, and/or other criteria.

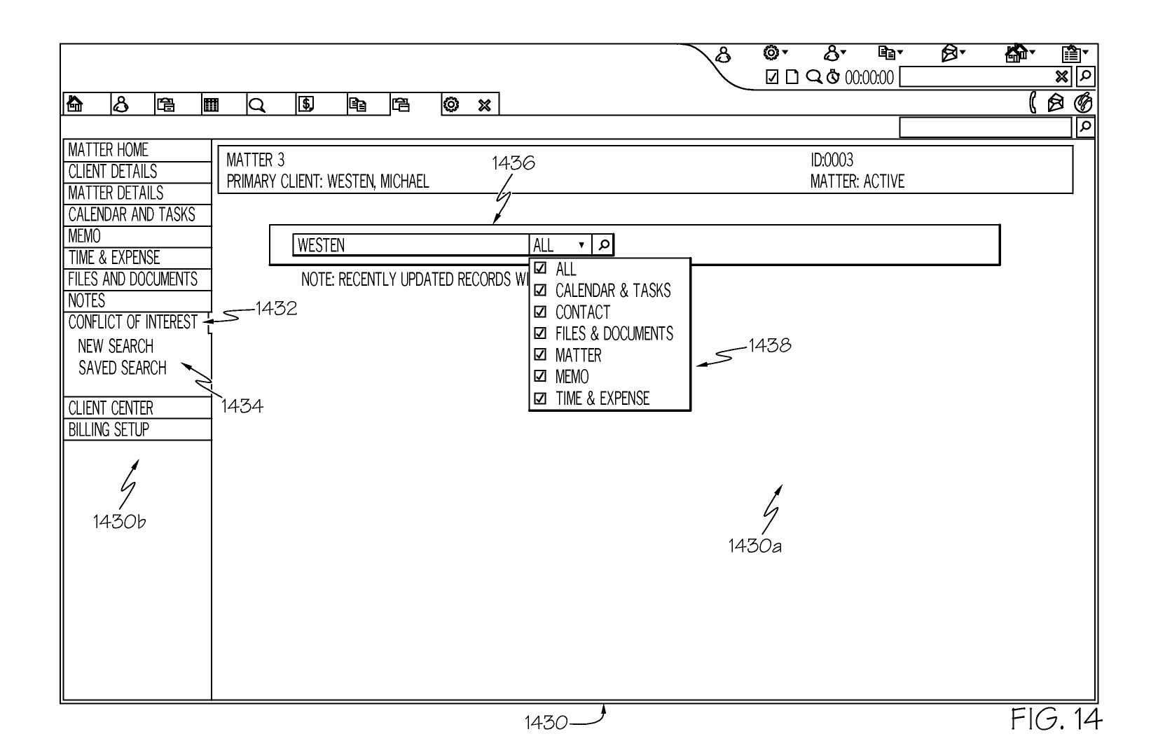

FIG. 14 depicts a conflict of interest interface 1430 for searching a conflict, according to one or more embodiments shown and described herein. As illustrated, the conflict of interest interface 1430 may include a conflict search frame 1430a and a sidebar frame 1430b. In response to selection of a conflict of interest option 1432 and/or new search sub-tab 1434, the conflict search frame 1430a may be provided. Regardless, the conflict search frame 1430a may provide a conflict of interest search function 1436 for performing a conflict of interest search client accounts described herein.

More specifically, many professionals, such as attorneys, cannot represent clients that conflict with the legal and/or business aspect of another client. As an example, if an attorney in Firm A represents a client that sues Acme Inc., no other attorney of Firm A may represent Acme, Inc., except under certain circumstances. Representation of Acme, Inc. in this example could result in penalties to the attorneys and/or Firm A, as a whole. Accordingly, attorneys often desire and/or are required to perform conflict checks when a new client and/or matter are brought to the firm. Thus, the conflict search frame 1430a may provide a mechanism for searching client accounts for this purpose. As conflict searching may be a prerequisite for adding the client and/or matter, some embodiments disclosed herein may limit user ability to filter search results. Accordingly, in the dropdown menu 1438, a predetermined number of filtering criteria are provided.

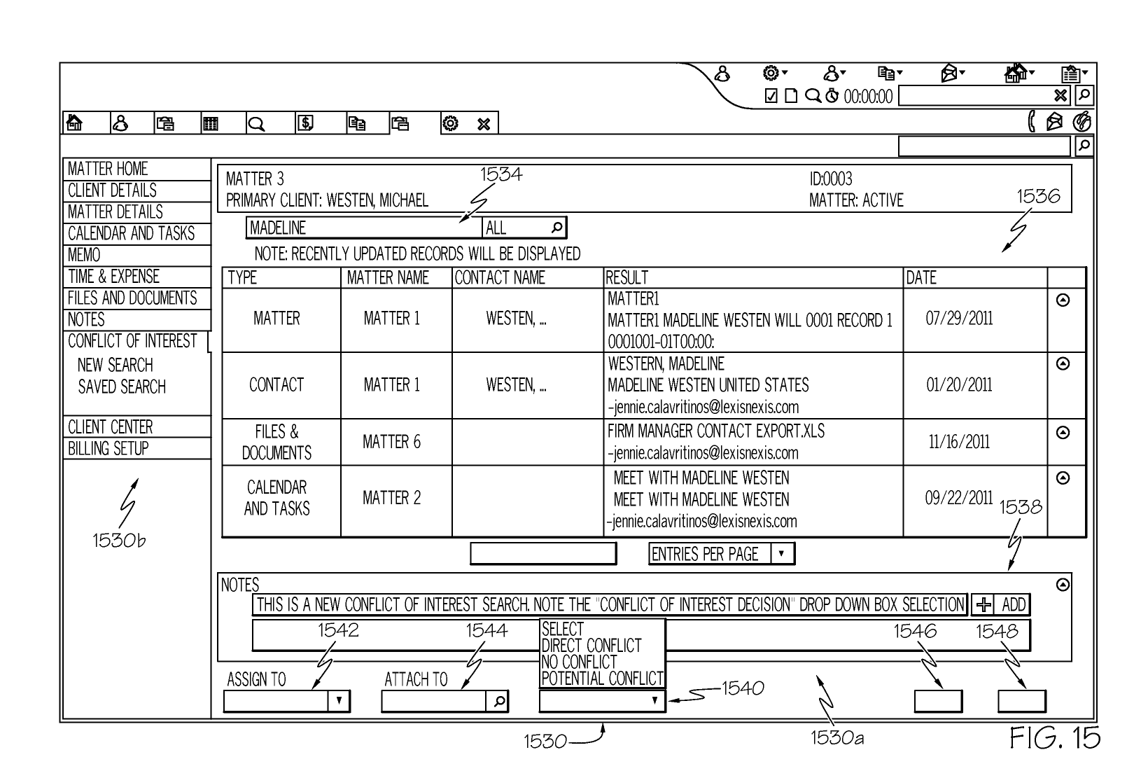

FIG. 15 depicts a conflict of interest interface 1530 for providing results to a conflict search, according to one or more embodiments shown and described herein. As illustrated, the conflict of interest interface 1530 includes a conflict search results frame 1530a and a sidebar frame 1530b. The conflict search results frame 1530a may be provided in response to performing the search from FIG. 14. Regardless, in response to a search of “Madeline” in the conflict search frame 1534, a plurality of search results are provided in search results section 1536. The search results section 1536 may provide the type of result, the matter name, the contact name, the result, the date, and/or other information for determining whether any of the results from different client accounts is likely a conflict of interest. Also included is a notes section 1538 for the user to input any notes related to the search. An “assign to” option 1542 may provide the user with the ability to contact another user of the search. As an example, if a search result is related to a client of John Smith (the client manager or responsible professional for that client), the user may assign the search to the client manager so that an alert may be sent to John Smith, so that he is aware of the potential conflict. Also included is an “attach to” option 1544 for attaching additional documentation to the search. A “conflict” option 1540 may be provided such that the user may designate whether the search resulted in a direct conflict, no conflict, or a potential conflict. In some embodiments, one of the designations in the conflict option 1540 may be automatically selected, based on a triggering search result. As an example, if the search reveals a pending litigation against the new client, the “potential conflict” designation may be automatically selected. A save option 1546 is provided for saving the search. Similarly, a discard option 1548 is provided for discarding the search.

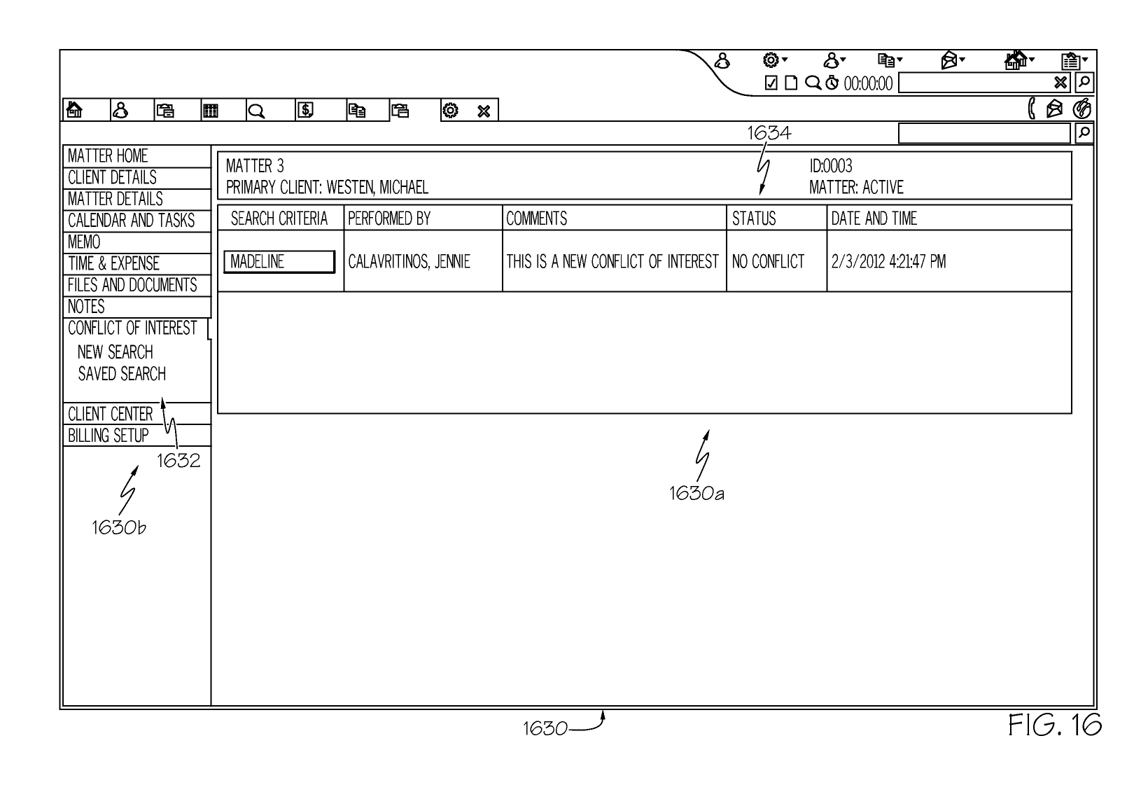

FIG. 16 depicts a conflict of interest interface 1630 for providing a saved conflict search, according to one or more embodiments shown and described herein. As illustrated, the conflict of interest interface 1630 may provide a saved search frame 1630a and a sidebar frame 1630b. In response to selection of a saved search option 1632, the saved search frame 1630a may be provided. Additionally, the saved search frame 1630a may include a saved conflict of interest search 1634 illustrating the search that was saved from FIG. 15. In response to selection of the saved conflict of interest search 1634, a conflict status and/or additional details regarding the search may be provided. Depending on the particular embodiment, the saved search may provide conflict status of a plurality of different client account for a plurality of different users.

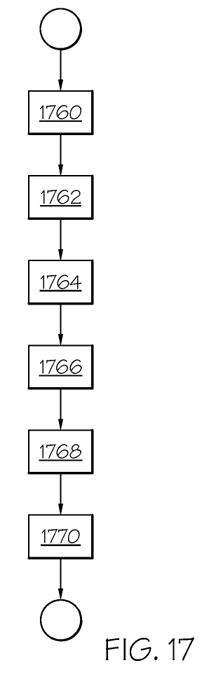

FIG. 17 depicts a flowchart for providing a practice area option, according to one or more embodiments shown and described herein. As illustrated in block 1760, providing an administrator interface may be provided that includes a practice area option to create a custom practice area grouping, the custom practice area grouping for assigning a client account, the client account relating to a practice area. In block 1762, an intake form option may be provided that includes a plurality of information sets. The intake form option may be utilized for selecting a preferred information set to be included in the intake form. The preferred information set may include a plurality of data fields. In block 1764, an option to include the intake form into the custom practice area grouping may be provided. In block 1766, in response to receiving an indication to include the intake form into the custom practice area grouping, the intake form may be included into the custom practice area grouping. In block 1768, a user interface may be provided for assigning a new client account to the custom practice area grouping. The user interface may include the plurality of data fields. The plurality of data fields may be configured for receiving user input that is specific to the new client account. In block 1770, in response to receiving information for at least one of the plurality of data fields, the new client account may be saved.

It should be understood that embodiments described herein may be configured to provide an organizational infrastructure for client accounts of a company, such as a law firm. Because of the organizational infrastructure, embodiments described herein may provide administrators the ability to customize the data that is requested, based on the type of client. This allows for the expanding the breadth of clients of a company into new areas without the need of purchasing different systems for each client type. Additionally, embodiments described herein also allow for the performance of conflict of interest checks across the differing data fields to determine if any of the clients or client matters pose a conflict of interest with a new client account. As such, professionals and/or administrators can have a single system for managing client rosters, while still maintaining ethical requirements on conflicts of interest.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for providing a practice area option comprising:
providing an administrator interface that includes a practice area option to create a custom practice area grouping, the custom practice area grouping for assigning a client account, the client account relating to a practice area;
providing an intake form option comprising a plurality of information sets, the intake form option for selecting a preferred information set to be included in an intake form, the preferred information set comprising a plurality of data fields;
providing an option to include the intake form into the custom practice area grouping;
in response to receiving an indication to include the intake form into the custom practice area grouping, including the intake form into the custom practice area grouping;
providing a user interface for assigning a new client account to the custom practice area grouping, the user interface comprising the plurality of data fields, the plurality of data fields configured for receiving user input that is specific to the new client account; and
in response to receiving information for at least one of the plurality of data fields, saving, by a computing device, the new client account.

2. The method of claim 1, further comprising providing a conflict of interest option for comparing at least a portion of the information for at least one of the plurality of data fields against similar fields for a different client account to determine a potential conflict.

3. The method of claim 2, further comprising providing a conflict of interest interface for providing a conflict status for a plurality of different client accounts.

4. The method of claim 1, further comprising providing a default practice area grouping that comprises a default intake form.

5. The method of claim 1, wherein the intake form option further comprises a default option to utilize an existing intake form as a template for the intake form.

6. The method of claim 1, wherein the plurality of data fields comprises at least one of the following: a matter name field, a matter identifier field, a description field, a client field, a client goal field, a referral source field, a practice area field, an intake form field, a responsible professional field, a jurisdiction field, an owner field, a team field, and an attached records field.

7. The method of claim 1, further comprising providing a global search function for searching any of a plurality of criteria related to the custom practice area grouping.

8. A system for providing a practice area option comprising:
a memory component that stores logic that, when executed by the system, causes the system to perform at least the following:
provide an administrator interface that includes a practice area option to create a custom practice area grouping, the custom practice area grouping for assigning a client account, the client account relating to a practice area;
an intake form option comprising a plurality of information sets, the intake form option for selecting a preferred information set to be included in an intake form, the preferred information set comprising a plurality of data fields;
receive a selection of the preferred information set from the plurality of information sets for including the plurality of data fields in the practice area grouping;
provide a conflict of interest option for comparing at least a portion of the information for at least one of the plurality of data fields against similar fields for a different client account to determine a potential conflict; and
in response to determining the potential conflict, send an alert to a client manager.

9. The system of claim 8, wherein the logic further causes the system to provide an conflict of interest interface for providing a conflict status for a plurality of different client accounts for a plurality of different users.

10. The system of claim 9, wherein the conflict of interest interface includes a conflict of interest search function to access a saved conflict of interest search.

11. The system of claim 8, wherein the logic further causes the system to provide a default practice area grouping that comprises a default intake form.

12. The system of claim 8, wherein the intake form option further comprises a default option to utilize an existing intake form as a template for the intake form.

13. The system of claim 8, wherein the plurality of data fields comprises at least one of the following: a matter name field, a matter identifier field, a description field, a client field, a client goal field, a referral source field, a practice area field, an intake form field, a responsible professional field, a jurisdiction field, an owner field, a team field, and an attached records field.

14. The system of claim 8, wherein the logic further causes the system to provide a global search function for searching any of a plurality of criteria related to the custom practice area grouping.

15. A system for providing a practice area option comprising:
a memory component that stores logic that, when executed by a computing device, causes the computing device to perform at least the following:
provide a user interface for assigning a new client account to a practice area grouping, the practice area grouping being created by an administrator through the use of a plurality of information sets that are grouped as an intake form, each of the plurality of information sets comprising a plurality of data fields, the user interface comprising the plurality of data fields for receiving user input that is specific to the new client account;
provide a conflict of interest option for comparing at least a portion of the information for at least one of the plurality of data fields against similar fields for a different client account to determine a potential conflict; and
in response to determining the potential conflict, send an alert to a user.

16. The system of claim 15, wherein the logic further causes the system to provide an engagement letter option for determining whether an engagement letter has been executed for the new client account.

17. The system of claim 15, wherein the logic further causes the system to provide a matter details option for providing additional information sets to the user, the additional information sets corresponding to the practice area grouping.

18. The system of claim 15, further comprising providing an intake form option for the user to select which previously created intake form to utilize of the new client account.

19. The system of claim 15, wherein the plurality of data fields comprises at least one of the following: a matter name field, a matter identifier field, a description field, a client field, a client goal field, a referral source field, a practice area field, an intake form field, a responsible professional field, a jurisdiction field, an owner field, a team field, and an attached records field.

20. The system of claim 15, wherein the logic further causes the system to provide a global search function for searching any of a plurality of criteria related to the practice area grouping.
